(19) United States
(12) Patent Application Publication
(10) Pub. No.: US 2017/0024831 A1
(43) Pub. Date: Jan. 26, 2017

(54) Systems and Methods for Social Networking

(71) Applicant: Michael L. Borkowski, Inverness, IL (US)

(72) Inventor: Michael L. Borkowski, Inverness, IL (US)

(21) Appl. No.: 15/218,007

(22) Filed: Jul. 23, 2016

Related U.S. Application Data
(60) Provisional application No. 62/196,843, filed on Jul. 24, 2015.

(51) Int. Cl. G06Q 50/00; G06Q 30/02

(52) U.S. Cl. CPC G06Q 50/01; G06Q 30/0214; G06Q 30/0261; G06Q 30/0266

(57) ABSTRACT

A method of delivering an advertisement and/or a message includes associating an account on a first social network with a first individual and allowing the first account to send a gesture to a second entity wherein the second entity is associated with a license plate. The second license plate can be associated with an advertiser. The advertiser can send the first individual an advertisement via the first social network. The method can further include determining that the advertiser is participating in a promotion and sending the first individual an advertisement via the first social network from the advertiser. In another embodiment, the method can further include determining that the advertiser is participating in a cross-posting promotion and granting an extra reward to the first individual when the first individual cross-posts the advertisement on a second social network. The advertisement can be a reward.

### CROSS-REFERENCE TO RELATED APPLICATION

This application relates to and claims priority benefits from U.S. Provisional Application No. 62/196,843 having a filing date of Jul. 24, 2015, entitled “Systems and Methods for Social Networking”. The '843 application is incorporated herein by reference in its entirety.

### FIELD OF THE INVENTION

The present invention relates to systems and methods for social networking, and, in particular, aspects of social networking related to mobile devices, and advertising and rewards.

### BACKGROUND OF THE INVENTION

A social networking system is a platform for building a social network of users with common interests, backgrounds, connections etc. A mobile social networking system is a social networking system in which users of the social network can participate via mobile devices.

Social media marketing is an approach to marketing based on gaining attention and customers through social media. One aspect of social media marketing is the ability of users of social media to interact directly with companies. Social media present opportunities to advertisers that go beyond traditional advertising techniques. As well as “word of web” that results from the publication and sharing of information via social media, advertisers can also use social media to provide incentives such as loyalty and reward programs, and electronic coupons, for example.

### SUMMARY OF THE INVENTION

A method of delivering an advertisement comprises:
(a) associating an account on a first social network with a first individual; and
(b) allowing the first account to send a gesture to a second entity wherein the second entity is associated with a license plate or name.

The second license plate or name can be associated with an advertiser. The advertiser can send the first individual an advertisement via the first social network.

The method can further comprise:
(c) determining that the advertiser is participating in a promotion; and
(d) sending the first individual an advertisement via the first social network from the advertiser.

In another embodiment, the method can further comprise:
(e) determining that the advertiser is participating in a cross-posting promotion; and
(f) granting an extra reward to the first individual when the first individual cross-posts the advertisement on a second social network.

The advertisement can be a reward.

A method of delivering an advertisement comprises:
(a) associating an account on a first social network with a first individual;
(b) associating the account with a trackable item;
(c) determining when the item is approaching a predetermined position or mobile transmitter;
(d) sending the advertisement to the first individual.

The trackable item can be a vehicle. The trackable item can also be a smartphone. Determining when the item is approaching a predetermined position can be performed utilizing information inputted into the smartphone. The method predetermined position can be a physical storefront associated with the advertisement.

In another embodiment, a method of connecting a first individual to a second individual comprises:
(a) associating an account on a first social network with the first individual;
(b) allowing the first individual to send a gesture on the first social network directed towards a second license plate or member name.

The gesture can be associated with the second individual's driving. The method second license plate can be associated with a second account which is associated with a second individual. The gesture can be stored on the first social network when the second license plate has not been claimed on the first social network. In some embodiments when the second license plate has not been claimed, the gesture is posted along with the second license plate. The gesture can also be cross-posted on a second social network.

### BRIEF DESCRIPTION OF THE DRAWINGS

FIG. 1 is a flow diagram of a method for processing a member gesture.

FIG. 2 is a flow diagram of a method for claiming a vehicle license plate.

FIG. 3 is a flow diagram illustrating a method for sending a gesture from a member to an advertiser by name.

FIG. 4 is a flow diagram illustrating a method for a member to send a gesture to an advertiser vehicle by license plate.

FIG. 5 is a flow diagram illustrating a method for earning a reward by passing a static (brick and mortar) advertiser location.

FIG. 6 is a flow diagram illustrating a method for earning a reward by passing an advertiser mobile device location.

FIG. 7 is a schematic diagram of a social network, according to a first illustrated embodiment.

FIG. 8 is a screenshot of a gesture-selection screen.

FIG. 9 is a screenshot of another example of a gesture-selection screen; in some embodiments this gesture selection screen appears when element 810 of FIG. 8 is activated.

FIG. 10 is a screenshot of a gesture-sending screen; in some embodiments gesture sending screen includes the ability to add text, photo, audio, and/or video content to the gesture. The user has chosen to send the gesture to a license plate.

FIG. 11 is a screenshot of a cross-posting screen.

FIG. 12 is a screenshot of a member-profile screen.

FIG. 13 is a screenshot of a posted-gestures screen.

FIG. 14 is a screenshot of an invite screen.

FIG. 15 is a screenshot of a profile-setup screen.

FIG. 16 is a screenshot of a vehicle-setup screen.

FIG. 17 is a screenshot of a coupons-earned screen.

FIG. 18 is a screenshot of a reward-creation screen.

FIG. 19 is a screenshot of a reward-transmit screen.

### DEFINITIONS

Social Networking System (also referred to in the description as the System): A system comprising at least one of a server application, a database, a web interface, an Application Program Interface (API), and a mobile application.

Member: A registered individual user of the social networking system.

Advertiser: A registered commercial user of the social networking system, with static (brick and mortar), and/or mobile device location(s), and/or vehicle license plate(s).

Member Gesture: One of several categorized communication types that a member can send to another member and/or an advertiser, by name or by vehicle license plate.

Public Gesture: One of several categorized communication types that a member can send to a non-member vehicle license plate by posting and/or cross-posting the communication to a public social media platform.

Reward: A benefit provided to a member by an advertiser based on a valid member gesture and/or proximity to an advertiser who has an active advertising campaign.

Cross-Post: Capability to publish a notification/message/reward to more than one social media platform.

Turbo: An advertiser's advertising campaign option to provide a member with additional reward(s) for cross-posting notification of a potentially reward-associated valid member gesture to that particular advertiser.

### DETAILED DESCRIPTION OF ILLUSTRATIVE EMBODIMENT(S)

The technology described in this disclosure relates to a social networking system with advertising opportunities and a reward system. Users of the social networking system include members and advertisers. The system is particularly suitable for mobile users, and is based on the sending of gestures (categorized communication types) from one member to another member, and from a member to an advertiser. The system includes the public posting of gestures to the system, and the cross-posting of gestures to other social networking sites.

The social networking system is linked to a reward system, such that rewards can be associated with the sending of gestures, and with active campaigns by advertisers.

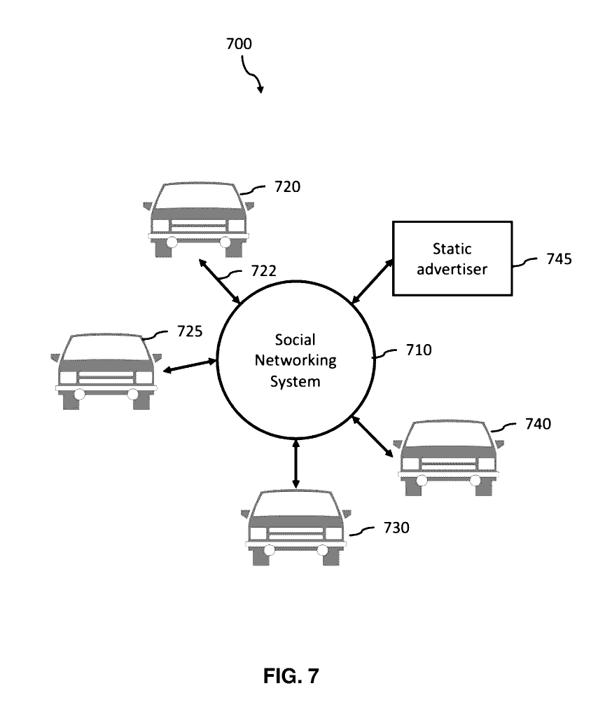

An example embodiment of the social networking system is described below in reference to FIG. 7.

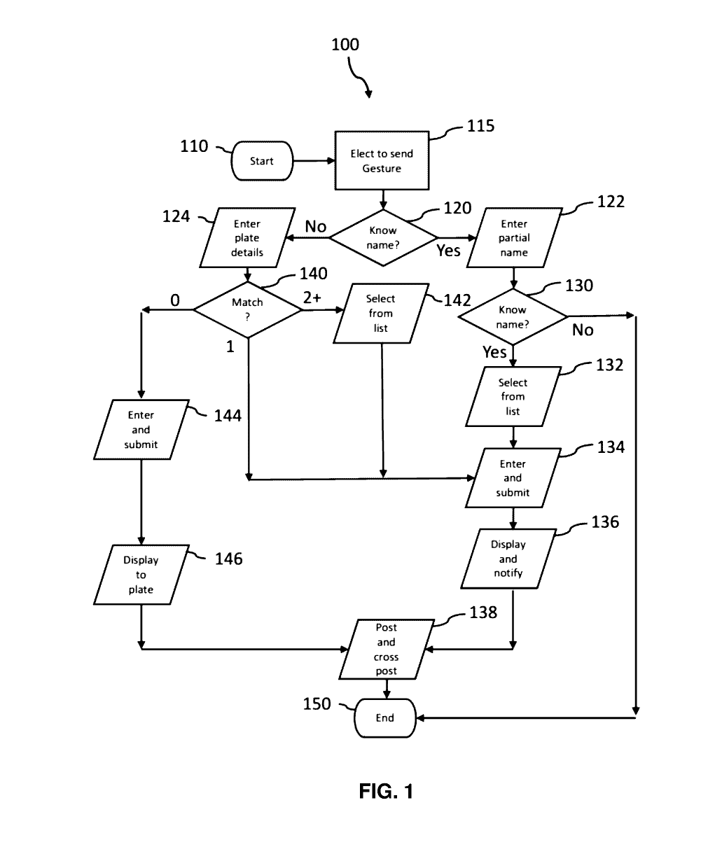

FIG. 1 is a flow diagram of method 100 for processing a member gesture. Method 100 starts at 110, for example on a power-up or power-on of a mobile device belonging to a member, or in response to an event causing the member (also known as the initiating member) to elect to send a gesture. In some embodiments the member signs onto a website to start method 100.

An example of an event causing the member to elect to send a gesture is courteous behavior by another driver, such as slowing down to let the member change lane.

At 115, the member elects to send a gesture to an intended recipient. The intended recipient can be identified by member name and/or by license plate, for example. At 120, the member determines whether the recipient can be identified by member name. If the member determines the recipient can be identified by member name, then control in method 100 proceeds to 122.

At 122, the member enters at least a partial name for the recipient into a user interface of a mobile application and/or a website. As the member enters characters of the recipient's name, the user interface can display a list of matching member names, optionally with further identifying details.

At 130, the system determines whether it can provide a list of member names matching the recipient's name. If not, control in method 100 proceeds to 150, and the method ends. If the system determines it can provide a list of member names matching the recipient's name, the system presents, on the user interface, a list of one or more member names matching the recipient's name, and control in method 100 proceeds to 132.

At 132, the member selects a name from the list of member names matching the recipient's name presented by the system on the user interface. At 134, the member initiates communication with the recipient by entering information related to a gesture selected from a list of available gestures, and submitting the information to the system.

At 136, the system processes and displays the selected gesture, and, depending on the recipient member's settings, optionally notifies the recipient member. At 138, the system posts and cross-posts the selected gesture in accordance with the member's settings. Control in method 100 proceeds to 150, and the method ends.

Referring again to 120 of FIG. 1, if the member determines the recipient cannot be identified by member name, control in method 100 proceeds to 124. At 124, the member enters the recipient's license plate information into the user interface of the mobile application and/or a website. At 140, the system determines whether it can provide a list of member names for which the license plate information matches the recipient's license plate information entered by the initiating member.

If the system provides exactly one matching member name, then control in method 100 proceeds to 134. At 134, the member initiates communication with the recipient by entering information related to a gesture selected from a list of available gestures, and submits the information to the system.

At 136, the system processes and displays the selected gesture, and, depending on the recipient member's settings, optionally notifies the recipient member. At 138, the system posts and cross-posts the selected gesture in accordance with the member's settings. Control in method 100 proceeds to 150, and the method ends.

Referring again to 140, if the system provides more than one matching member name, then control in method 100 proceeds to 142. At 142, the member selects a name from the list of member names matching the recipient's name presented by the system on the user interface, and proceeds to 134 where the member initiates communication with the recipient by entering information related to a gesture selected from a list of available gestures, and submits the information to the system. At 136, the system processes and displays the selected gesture, and, depending on the recipient member's settings, optionally notifies the recipient member. At 138, the system posts and cross-posts the selected gesture as determined by the member's settings. Control in method 100 proceeds to 150, and the method ends.

Referring again to 140, if the system determines it is unable to provide a matching name, control in method 100 proceeds to 144, where the member enters information related to a gesture selected from a list of available gestures, and submits the information to the system. At 146, the system processes and displays the gesture as a public gesture. At 138, the system posts and cross-posts the selected gesture as determined by the member's settings. Control in method 100 proceeds to 150, and the method ends.

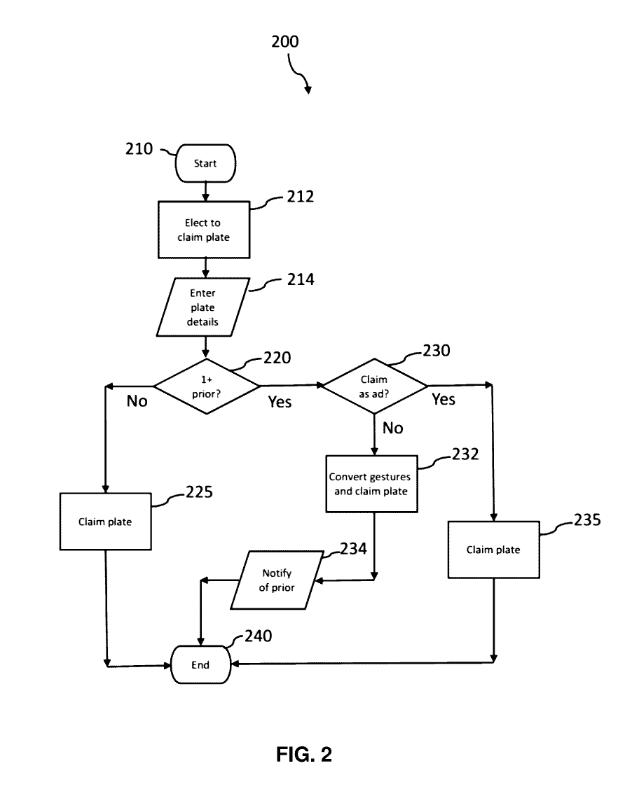

FIG. 2 is a flow diagram of method 200 for claiming a vehicle license plate. Method 200 starts at 210, for example on a power-up or power-on of a mobile device belonging to a member, or in response to an event causing the member (also known as the initiating member) to elect to claim a license plate. In some embodiments the member signs onto a website to start method 200. In certain embodiments, joining a social network will cause the member to elect to claim a license plate.

At 212, the member (also known as the claiming member) elects to claim the license plate, and, at 214, the member enters license plate details into the user interface for the mobile application. At 220, the system determines whether there have been prior public gestures associated with the license plate being claimed. If not, then, at 225, the license plate is claimed, processing is complete, and control in method 200 proceeds to 240 where the method ends.

If the system determines there have been prior public gestures associated with the license plate being claims, then, at 230, the system determines whether the member is claiming the vehicle license plate as an individual or as an advertiser. If the system determines the member is claiming the license plate as an advertiser, then, at 235, the vehicle license plate is claimed, processing is complete, and control in method 200 proceeds to 240 where the method ends.

If the system determines at 230 that the member is claiming as an individual, then, at 232, the system converts all prior non-advertiser public gestures to member gestures and the vehicle license plate is claimed. At 234, the system notifies the claiming member of prior gestures according to member settings, processing is complete, and control in method 200 proceeds to 240 where the method ends.

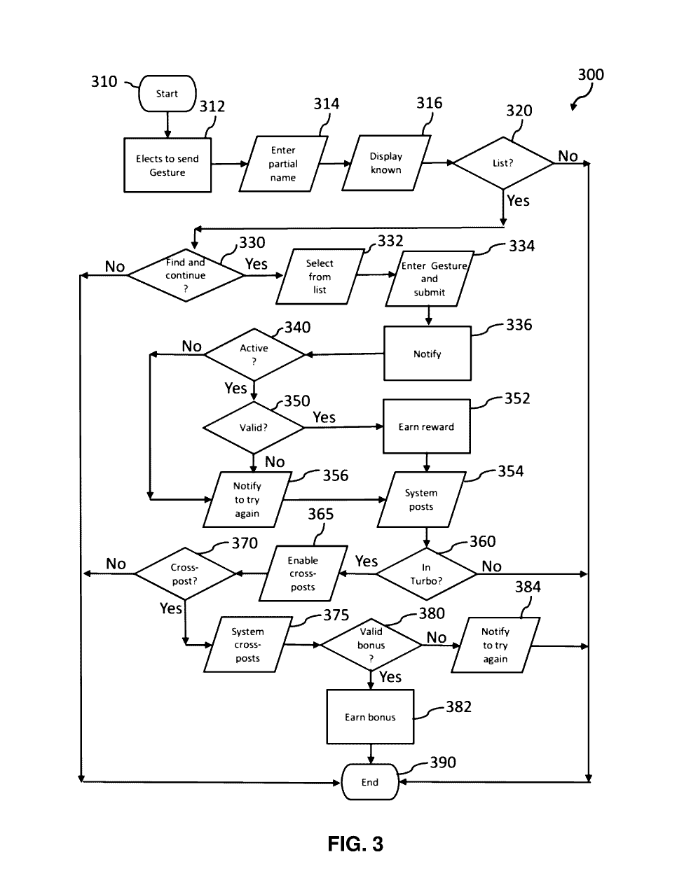

FIG. 3 is a flow diagram illustrating method 300 for sending a gesture from a member to an advertiser by name. Method 300 starts at 310, for example on a power-up or power-on of a mobile device belonging to a member, or in response to an event causing the member (also known as the initiating member) to elect to send a gesture from the member to an advertiser (also known as the target advertiser) by name. In some embodiments the member signs onto a website to start method 300.

At 312, the initiating member selects from one of the available gestures with which to initiate contact with the target advertiser by name. At 314, the member enters at least a partial name for the advertiser into the user interface of the mobile application and/or website. At 316, as the member enters characters of the recipient's name, the system, via the user interface, can display a list of matching member and/or advertiser names, optionally with further identifying details. As is true throughout the entire application, unless otherwise specified or necessitated by logic, the various methods are not limited to the order in which the steps are described. For example, in some embodiments of method 300 the member enters at least a partial name for the advertiser before selecting one of the available gestures.

At 320, the system determines whether it can provide a list of member names and/or advertiser names matching the partial name information entered by the initiating member. If not, then control in method 300 proceeds to 390, processing completes and method 300 ends.

If the system determines it can provide a list of member names and/or advertiser names matching the partial name information entered by the member, then, at 330, the system determines whether the member can find the target advertiser and wishes to continue. If not, then control in method 300 proceeds to 390, processing completes and method 300 ends.

If the system determines the member can find the target advertiser and wishes to continue, then, at 332, the member selects a name from the list of names matching the target advertiser's name presented by the system on the user interface, and proceeds to 334 where the member initiates communication with the advertiser by entering information related to a gesture selected from a list of available gestures, and submitting the information to the system. At 336, the system processes the advertiser gesture and, depending on the target advertiser's settings, optionally notifies the target advertiser.

The target advertiser may or may not have an active advertising campaign. At 340 and 350, the system determines whether the target advertiser has an active advertising campaign and if there is a reward associated with the advertiser gesture. If not, then control in method 300 proceeds to 356, where the member is notified that the gesture did not generate a reward, and that the member should try again. In some embodiments the system then proceeds to 354 and posts the gesture in accordance with the member's settings.

If, at 340 and 350, the system determines that the target advertiser has an active advertising campaign and there is a reward associated with the advertiser gesture, then, at 352, the member earns the reward associated with the advertiser gesture.

At 354, the system posts the gesture in accordance with the member's settings.

The advertiser may or may not have subscribed to Turbo (see definitions above). At 360, the system determines whether the advertiser has subscribed to Turbo. If not, then control in method 300 proceeds to 390, processing is complete, and method 300 ends.

If, at 360, the system determines Advertiser has subscribed to Turbo, then the system enables an option for the member to cross-post at 365, in accordance with the member's settings. At 370, the member chooses whether to elect to cross-post the gesture to the advertiser. If the member chooses not to cross-post, control in method 300 proceeds to 390, processing is complete, and method 300 ends.

If, at 370, the member elects to cross-post, the gesture to the advertiser is cross-posted at 375, in accordance with the member's settings. At 380, the system determines whether the advertiser has a bonus reward associated with the cross-post. If not, then, at 384, the member is notified that there was no bonus reward associated with the cross-post, and that the member should try again. Control in method 300 proceeds to 390, processing is complete, and method 300 ends.

If, at 380, the system determines there is a bonus reward associated with the cross-post, then, at 382, the member earns the bonus reward associated with the cross-post. At 390, processing is complete and method 300 ends.

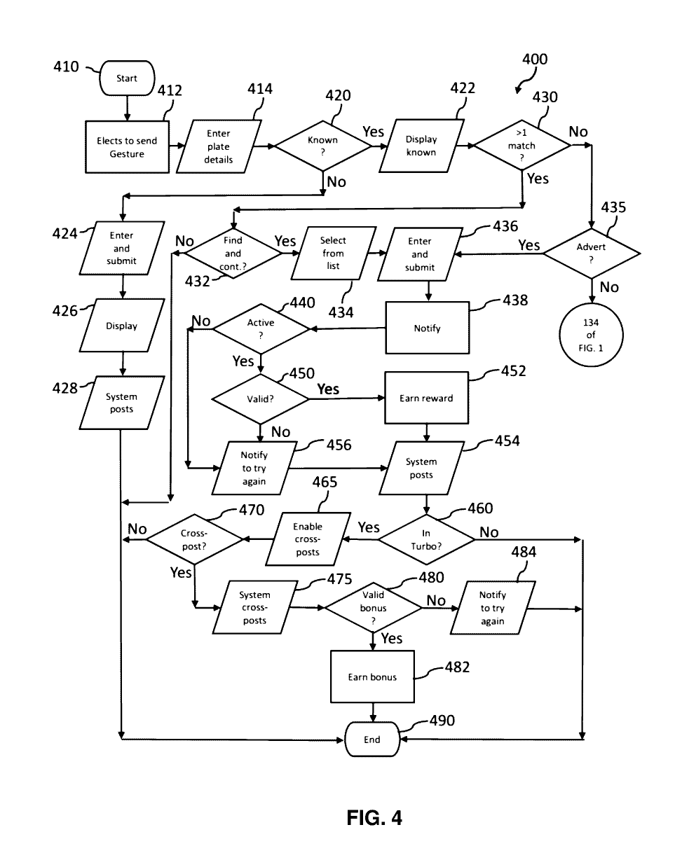

FIG. 4 is a flow diagram illustrating method 400 for a member to send a gesture to an advertiser vehicle by license plate. Method 400 starts at 410, for example on a power-up or power-on of a mobile device belonging to a member, or in response to an event causing the member (also known as the initiating member) to elect to send a gesture from the member to an advertiser vehicle by license plate. In some embodiments the member signs onto a website to start method 400.

At 412, the initiating member elects to send a gesture to an advertiser vehicle by license plate. In some embodiments the member can create his or her own gesture. In other or the same embodiments, some gestures are provided. At 414, the member enters the advertiser vehicle's license plate in a user interface on the mobile device and/or website. At 420, the system determines whether the advertiser vehicle's license plate details are associated with a known advertiser. If not, then, at 424, the initiating member enters details of a gesture, selected from available gestures, to initiate the communication. At 426, the system processes and displays the communication as a public gesture. At 428, the system posts the gesture, in accordance with the member's settings. At 490, processing is complete, and method 400 ends.

If, at 420, the system determines the advertiser vehicle's license plate details are associated with a known advertiser then, at 422, the system presents a list of matching target advertiser and member names, along with identifying information. If, at 430, the system determines there is more than one match, and, at 432, the member finds the target advertiser and chooses to continue, then control in method 400 proceeds to 434. At 434, the member selects the advertiser from the list, and, at 436, enters details of a gesture, selected from available gestures.

If, at 430, the system determines there is more than one match, and, at 432, the member chooses not to continue, then control in method 400 proceeds to 490, where processing completes and method 400 ends.

If, at 430, the system determines there is only one match, and, at 435, the match is not advertiser, then control in method 400 proceeds to 134 of FIG. 1. If, at 430, the system determines there is only one match, and, at 435, the match is an advertiser, then control in method 400 proceeds to 436, where the member enters details of a gesture selected from available gestures.

At 438, the system processes the member's gesture and, depending on the target advertiser's settings, optionally notifies the target advertiser.

The target advertiser may or may not have an active advertising campaign. At 440 and 450, the system determines whether the target advertiser has an active advertising campaign and there is a reward associated with the member's gesture. If not, then control in method 400 proceeds to 456, where the member is notified that the gesture did not generate a reward, and that the member should try again. In at least some embodiments, the system still posts the gesture.

If, at 440 and 450, the system determines that the target advertiser has an active advertising campaign and there is a reward associated with the member's gesture, then, at 452, the member earns the reward associated with the advertiser gesture. In certain embodiments, an advertiser can decide to only offer rewards if the member posts a particular gesture.

At 454, the system posts the gesture in accordance with the member's settings.

The advertiser may or may not have subscribed to Turbo. At 460, the system determines whether the advertiser has subscribed to Turbo. If not, then control in method 400 proceeds to 490, processing is complete, and method 400 ends.

If, at 460, the system determines Advertiser has subscribed to Turbo, then the system enables an option for the member to cross-post at 465, in accordance with the member's settings. At 470, the member chooses whether to elect to cross-post the gesture to the advertiser. If the member chooses not to cross-post, control in method 400 proceeds to 490, processing is complete, and method 400 ends.

If, at 470, the member elects to cross-post, the gesture to the advertiser is cross-posted at 475, in accordance with the member's settings. At 480, the system determines whether the advertiser has a bonus reward associated with the cross-post. If not, then, at 484, the member is notified that there was no bonus reward associated with the cross-post, and that the Member should try again. Control in method 400 proceeds to 490, processing is complete, and method 400 ends.

If, at 480, the system determines there is a bonus reward associated with the cross-post, then, at 482, the member earns the bonus reward associated with the cross-post. At 490, processing is complete and method 400 ends.

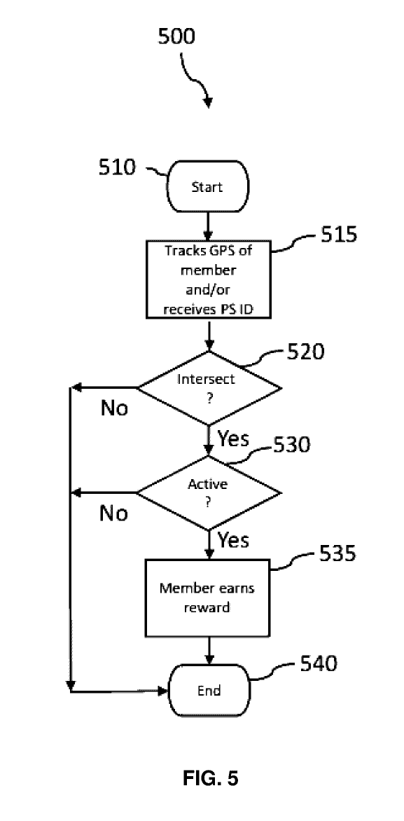

FIG. 5 is a flow diagram 500 illustrating method 500 for earning a reward by passing a static (brick and mortar) advertiser location. Method 500 starts at 510, for example on a power-up or power-on of a mobile device belonging to a member, or in response to an event causing the member (also known as the initiating member) to pass a static advertiser location.

At 515, the mobile application receives two consecutive GPS locations, indicating the member is moving in a particular direction, and/or receives an identifier from a proximity sensor (PS) such as a Bluetooth Low Energy (BLE) Positioning System or an Apple iBeacon.

If, at 520 and 530, the system determines that the member's mobile device location intersected with an advertiser's static location settings and the advertiser has an active campaign, then, at 535, the member earns the reward associated with the advertiser's campaign and method 500 proceeds to 540 and ends. If the system determines the advertiser does not have an active campaign at 530, the control in method 500 proceeds to 540. At 540, processing completes, and method 500 ends.

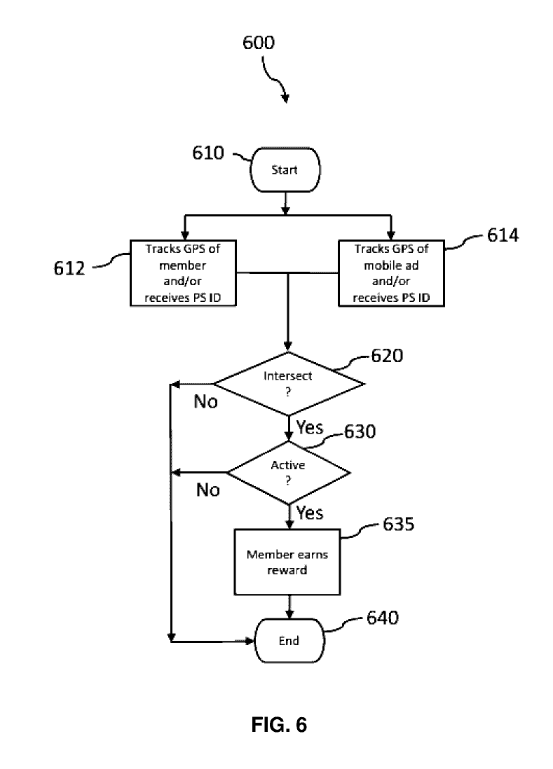

FIG. 6 is a flow diagram illustrating method 600 for earning a reward by passing an advertiser mobile device location. Method 600 starts at 610, for example on a power-up or power-on of a mobile device belonging to a member, or in response to an event causing the member (also known as the initiating member) to pass an advertiser mobile device location.

At 612, the mobile application receives two consecutive GPS locations, indicating the member is moving in a particular direction, and/or receives an identifier from a proximity sensor (PS) such as a Bluetooth Low Energy (BLE) Positioning System or an Apple iBeacon. At 614, the mobile application on the advertiser's mobile device receives two consecutive GPS locations, indicating the advertiser's mobile device is moving in a particular direction, and/or receives an identifier from a proximity sensor (PS) such as a Bluetooth Low Energy (BLE) Positioning System or an Apple iBeacon.

At 620, the system compares the location, direction, and range of the member's mobile device location with the location, direction, and range of at least one advertiser's mobile device, and/or looks up the associated advertiser details associated with the identifier from the proximity sensor (PS). If, at 620 and 630, the system determines that the member's mobile device location intersected with an advertiser's mobile device location settings and the advertiser has an active campaign, then, at 635, the member earns the reward associated with the advertiser's campaign and method 600 proceeds to 640 and ends. If the system determines the advertiser does not have an active campaign at 630, the control in method 600 proceeds to 640. At 640, processing completes, and method 600 ends.

FIG. 7 is a schematic diagram of social network 700, according to a first illustrated embodiment. Social network 700 comprises social networking system 710. Social network 700 further comprises a plurality of individuals such as members registered members 720 and 725. Information about members 720 and 725 registered with social networking system 710 can include member name and license plate. Non-members, such as non-member 730, can interact with public elements of social networking system 710.

Advertisers can be members of social network 700. Advertisers can comprise mobile locations, such as mobile location 740, and static locations, such as static location 745. Mobile location 740 can be determined by a mobile transmitter such as, but not limited to, a smartphone. In some embodiments, mobile location 740 is affiliated with a vehicle. For example, an advertiser can place a mobile transmitter on their delivery trucks, which then can interact, either actively or passively with registered members 720 and 725. In other embodiments mobile location 740 is affiliated with an individual.

Members, such as member 720, can communicate with social networking system 710 via communication interface 722. Member 720 can also initiate communication with another member, such as member 725, by sending a gesture to social networking system 710 via communication interface 722. In some embodiments member 720 can also communicate with non-member 730 by posting to social networking system 710 which then cross-posts on other social networks.

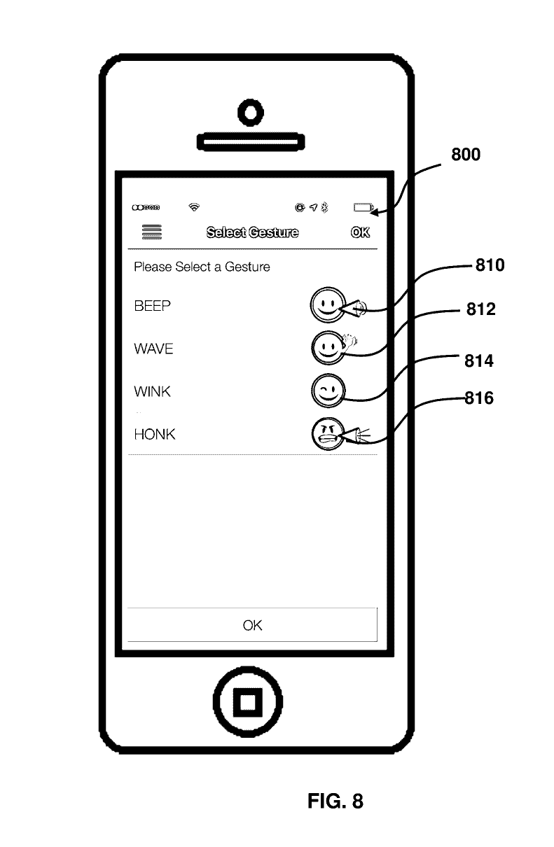

FIG. 8 is a screenshot of gesture-selection screen 800. Gesture-selection screen 800 can includes a list of possible gestures available for selection. In the embodiment shown, these gestures comprise “beep” gesture 810, “wave” gesture 812, “wink” gesture 814 and “honk” gesture 816. In other embodiments, other gestures can be used including user created gestures. In some embodiments, users can download groups of gestures from third parties.

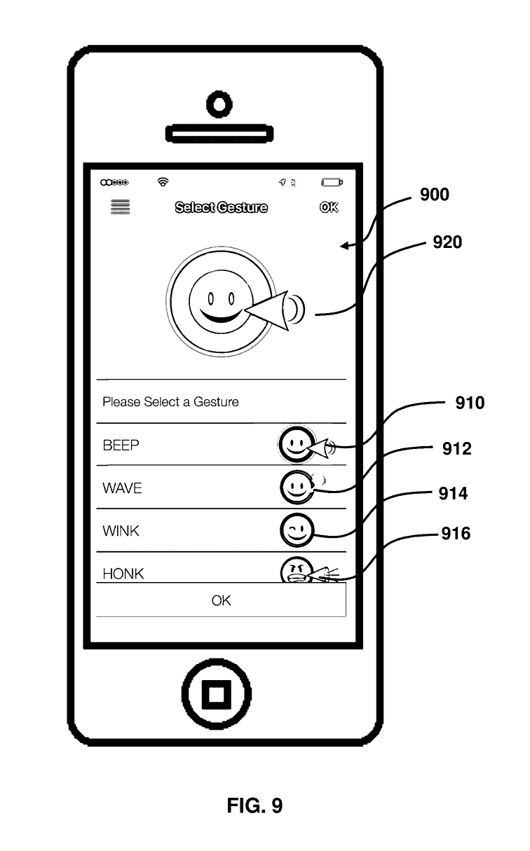

FIG. 9 shows a screenshot of gesture-selection screen 900. In this embodiment, the gesture selected, “beep” gesture 910, is magnified in gesture selected box 920. “Wave” gesture 912, “wink” gesture 914 and “honk” gesture 916 are also present. In some embodiments, gesture-selection screen 900 appears after a gesture from gesture-selection screen 800 is activated.

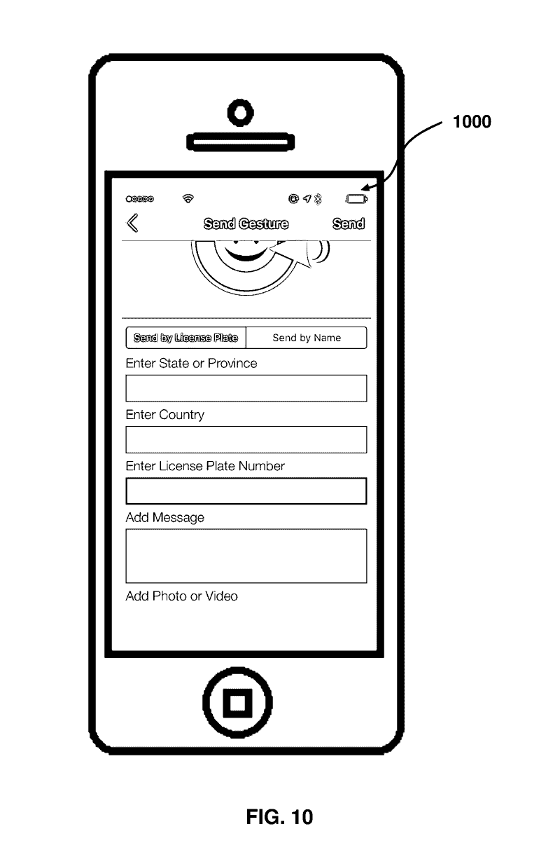

FIG. 10 shows a screenshot of a gesture-sending screen 1000. In some embodiments, the gesture can be sent to a target specified by the target license plate. In some embodiments, the state license plate information will prefill based on a user's GPS location. In some embodiments, the state license plate information will prefill based on a user's profile location. In some embodiments, the gesture can be sent to a target specified by a user name and/or a user's profile name.

In some embodiments, gesture-sending screen 1000 includes the ability to add text, photo, audio, and/or video content to the gesture.

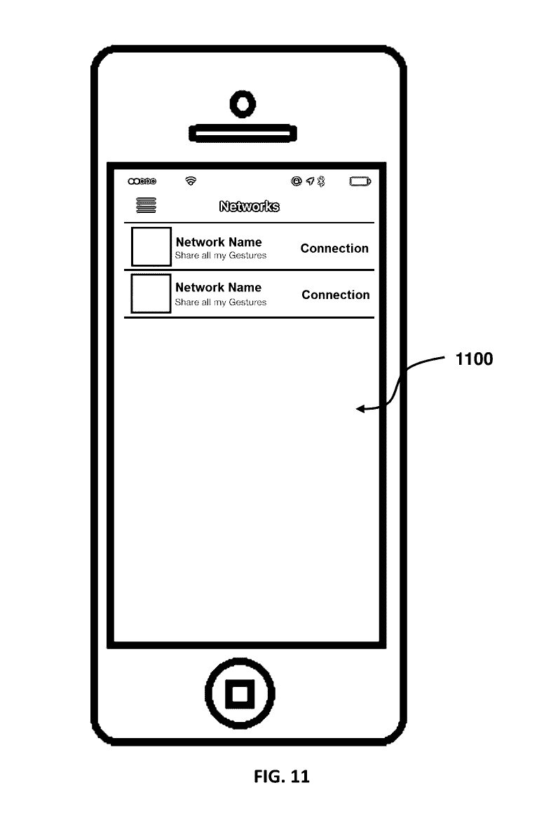

FIG. 11 shows a screenshot of cross-posting screen 1100. In some embodiments, cross-posting screen 1100 has a plurality of available social networks with which a user can select to cross-post.

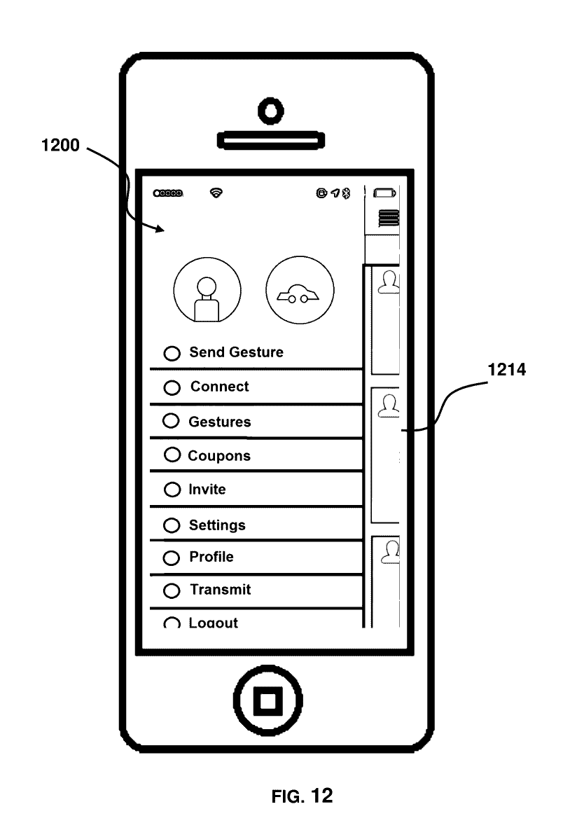

FIG. 12 shows a screenshot of member-profile screen 1200. In some embodiments, member-profile screen 1200 is within a social networking system. Member-profile screen 1200 can include, among other things, member photo 1210, vehicle photo 1212, and at least one social post 1214.

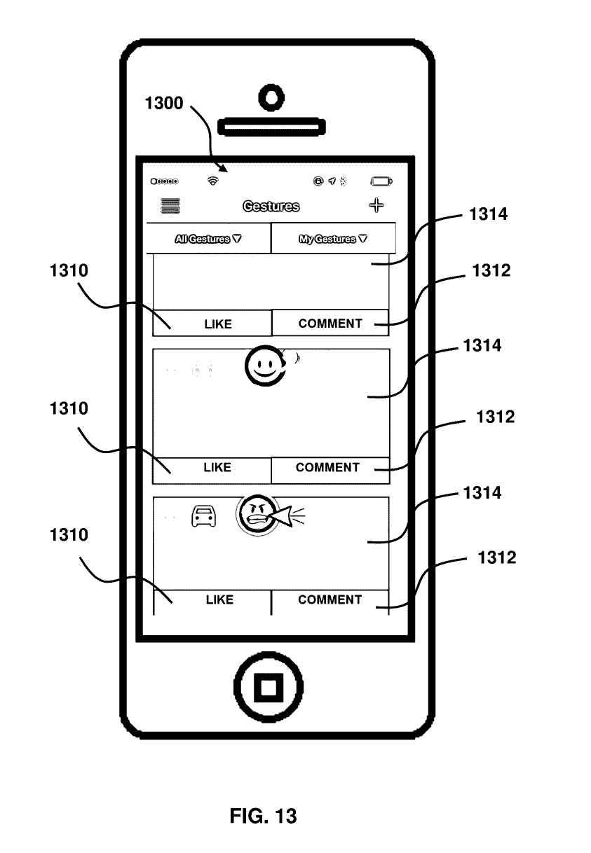

FIG. 13 illustrates a screenshot of posted-gestures screen 1300. In some embodiments, posted-gestures screen 1300 allows for, among other things, the viewing of posts 1314 by users. In the shown embodiment, a plurality of soft buttons 1310 and 1312, can be used to “like” and/or “comment” on posts 1314. In some embodiments, members can share and/or cross-post a post 1314 from posted-gestures screen 1300. In some embodiments, a member can delete a post he/she created.

In some embodiments, posted-gesture screen can organize posts into various categories, such as but not limited to, all gestures, all gesture originating from other members and/or advertisers, gestures made by members to non-users, gestures directed to or from other members, gestures directed to or from advertisers.

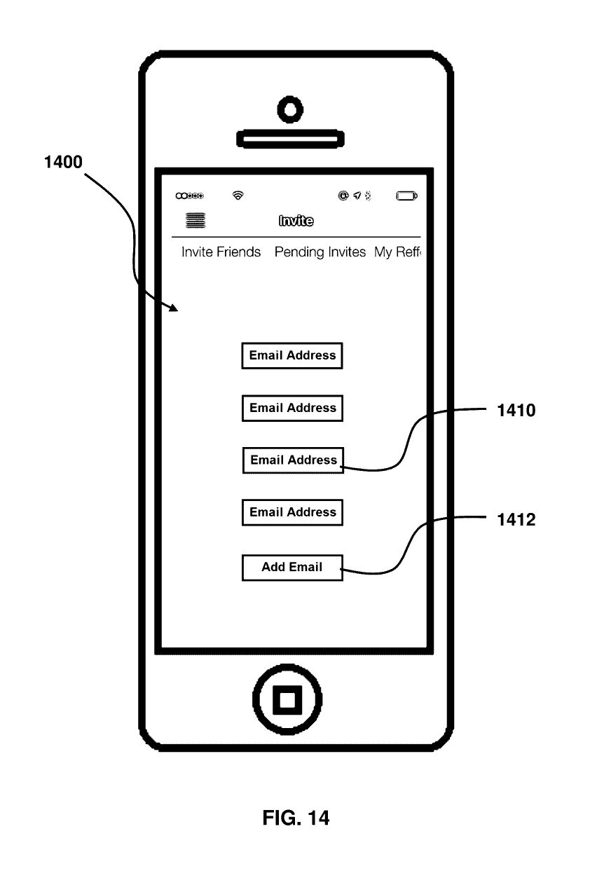

FIG. 14 shows invite screen 1400. In some embodiments of invite screen 1400 members can invite non-members to join the social networking system. In the embodiment shown in FIG. 4, users can invite nonusers by using non-member e-mail address 1410. In some embodiments, button 1412 allows for adding e-mail addresses to populate a list such that multiple potential members can be invited at once. In some embodiments of invite screen 1400, member can invite nonusers by using a list populated from a second social network.

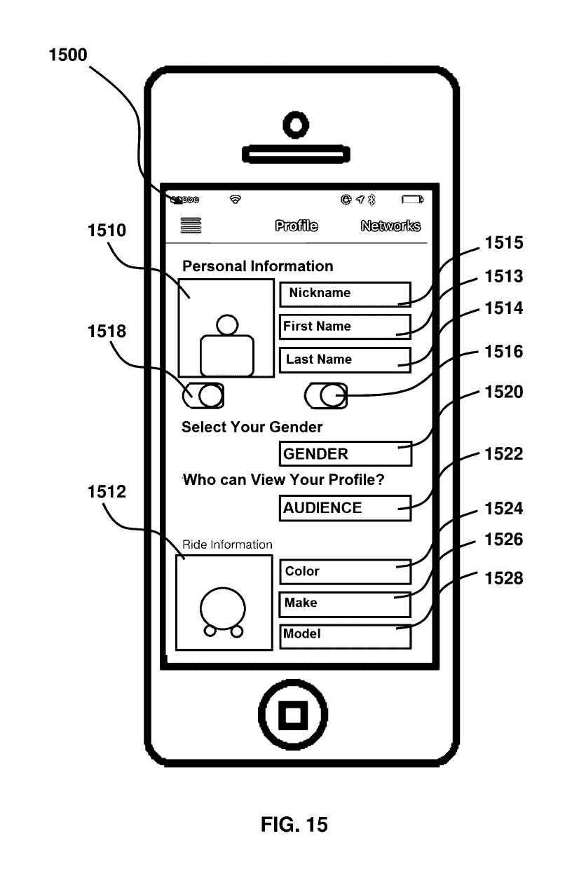

FIG. 15 shows profile-setup screen 1500. In the embodiment shown, profile-setup screen 1500 allows members to select member photo 1510 to represent themselves and/or vehicle photo 1512 to represent their vehicle. In some embodiments, member photo 1510 and/or vehicle photo 1512 can be animated.

In some embodiments, profile-setup screen 1500 can allow members to input a nickname into text field 1515, their first name into text field 1513, and their last name into text field 1514. In some embodiments, a member can use soft button 1518 to hide their first name from their profile and/or soft button 1516 to hide their last name. In some embodiments, the member can select their gender from gender list 1520, and/or select an audience for their profile from audience list 1522. In some embodiments, regardless of what a member chooses from audience list 1522 the member's license plate is not visible to anyone other than the member and an administrator.

In some embodiments of profile-setup screen 1500, members can input information regarding their vehicle, including the color in color field 1524, make in make field 1526, and model in model field 1528.

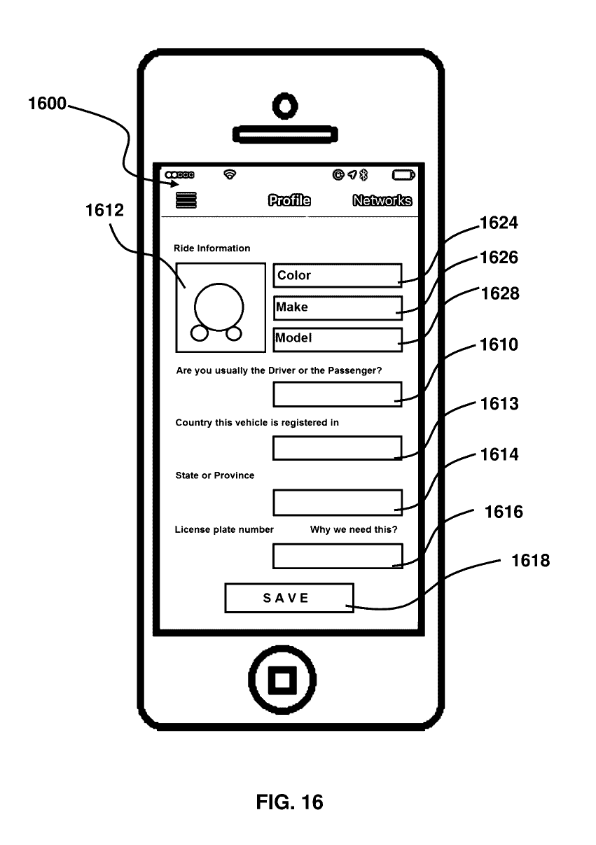

FIG. 16 shows vehicle-setup screen 1600. Vehicle-setup screen 1600 allows members to adjust information regarding their vehicle such as, but not limited to, the color in color field 1624, make in make field 1626, and model in model field 1628. In some embodiments, vehicle-setup screen 1600 is a subpart of and/or can be activated from profile-setup screen 1500.

In some embodiments, vehicle-setup screen 1600 can include information regarding whether the member is usually a driver or passenger in field 1610, country of vehicle registration in field 1613, state or province of vehicle registration in field 1614, license plate number in field 1916, and the ability to save the data from this menu for later recall with soft button 1618. These features can be present in various combinations, orders, and/or selections.

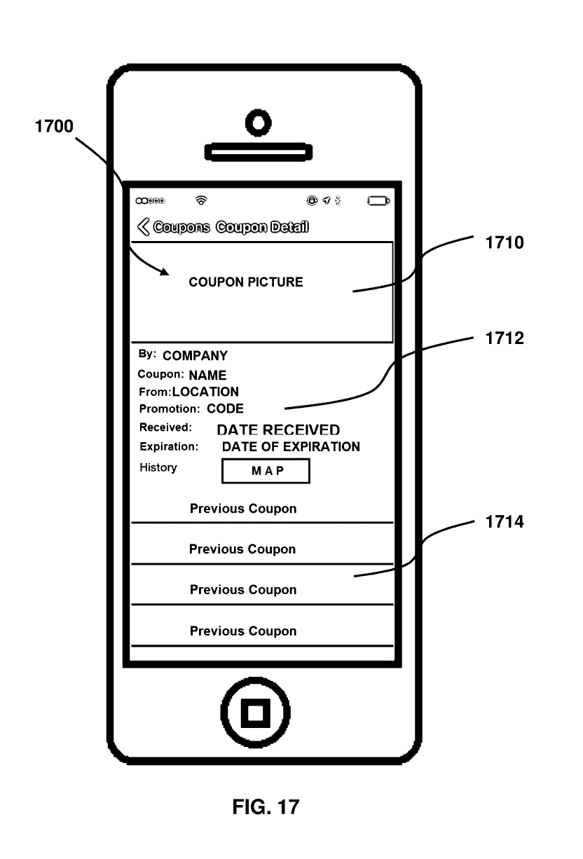

FIG. 17 shows a screenshot of coupons-earned screen 1700. In some embodiments, image 1710 accompanies the reward. In some embodiments, information about the reward is shown in field 1712, and/or a menu of previously gathered rewards by a member is available in field 1714.

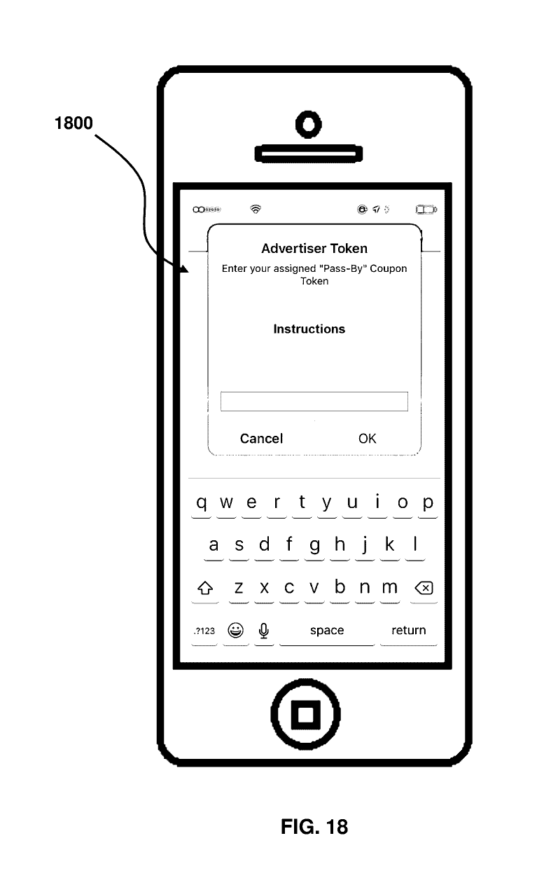

FIG. 18 shows a screenshot of rewards-creation screen 1800. Rewards-creation screen 1800 allows an advertiser to create a reward. In some embodiments, rewards-creation screen 1800 can include a series of prompts to guide an advertiser through the process.

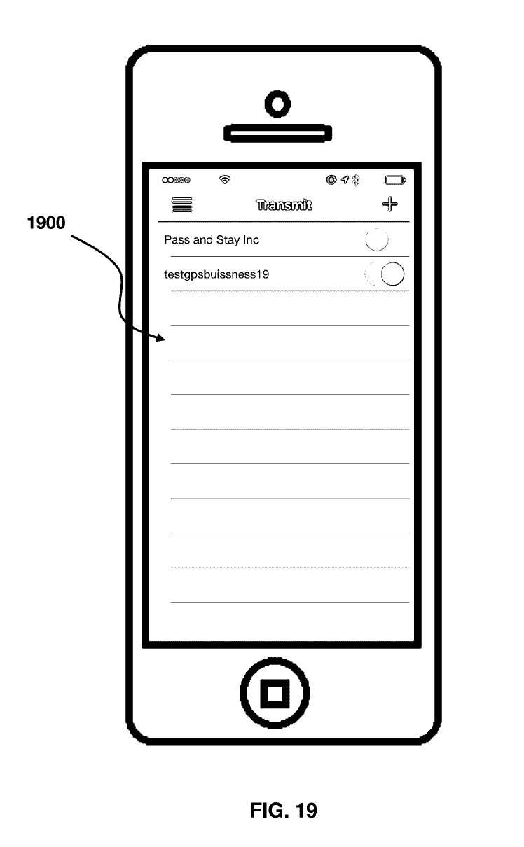

FIG. 19 shows a screenshot of rewards-transmit screen 1900. In some embodiments, rewards-transmit screen 1900 allows an advertiser to select from a list of rewards to transmit from a mobile device if accompanied with embodiments such as those described by FIG. 6 and/or a static device if accompanied with embodiments such as those described by FIG. 5.

In some embodiments, gestures can include audio, video, text, and/or photographic content. This content can be uploaded from a device interacting with the social networking system. Examples of such devices can include, but should not be limited to, mobile devices. Video, audio, and photographic content can be sourced from a variety of sources, such as dash cameras, in-car audio/entertainment systems, in-car telecommunication systems, rear view cameras, mobile devices, wearable cameras, or driver habit monitoring devices provided in conjunction with insurance plans.

In some embodiments, nearby members of the social networking system can be identified using recognition systems. Recognition systems can have the capability to identify license plates or electronically networked tags of other members. In some embodiments, a recognition system can identify a member's license plate using a rear-view camera, dash camera, or mobile device camera. In some embodiments, recognition systems can be configured to recognize a user speaking a license plate or member name. In some embodiments, recognition systems can use GPS and/or Bluetooth enabled devices to recognize other devices linked to the social networking system in the proximity of the user. In some embodiments, recognition systems can identify radio-frequency identification (RFID) tags associated with members of the social networking system.

In some embodiments, recognition systems can assist members in inputting data (such as at 124 of control method 100, or 214 of method 200). In 124 of control method 100, a recognition system could input license plate information for the user, such as the plate number and/or plate state. This can be done by the user reading the plate number to the recognition system aloud and/or by the recognition system gathering the requested information from a video and/or photograph.

In some embodiments, the social networking system can interact with radar or laser detection systems via wired or wireless connections. Notification of detected lasers or radar can be used by the social networking system to alert users of the social networking system within the proximity of the laser or radar detection system. This alert can be performed automatically or by a user. In some embodiments, the social networking system has access to at least one database containing locations of traffic and speed cameras. In some embodiments, the social networking system has access to at least one database containing local traffic conditions, which can be transmitted to devices on the social networking system to alert them of nearby traffic conditions such as, but not limited to, lane closures and AMBER alerts.

In some embodiments recognition systems can be used to read bumper stickers.

In some embodiments the social networking system can include a treasure hunt feature, wherein members can enter a destination address and have locations of rewards along possible routes identified.

In some embodiments, members are able to voice chat directly with other members.

In some embodiments, members can receive notifications when they are near other members. These embodiments can include an invitation to send a gesture to the nearby member. In some embodiments, the option to send a gesture is only be available when the user is not moving. In other embodiments, the option to send a gesture can be chosen using a voice activated system.

The above described embodiments can be used individually or in various suitable combinations.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A method of delivering an advertisement comprises:
(a) associating an account on a first social network with a first individual; and
(b) allowing said first account to send a gesture to a second entity wherein said second entity is associated with a license plate.

2. The method of claim 1, wherein said second license plate is associated with an advertiser.

3. The method of claim 2, wherein said advertiser sends said first individual an advertisement via said first social network.

4. The method of claim 2, further comprising:
(c) determining that said advertiser is participating in a promotion; and
(d) sending said first individual an advertisement via said first social network from said advertiser.

5. The method of claim 4, further comprising:
(e) determining that said advertiser is participating in a cross-posting promotion; and
(f) granting an extra reward to said first individual when said first individual cross-posts said advertisement on a second social network.

6. The method of claim 4, wherein said advertisement is a reward.

7. A method of delivering an advertisement comprises:
(a) associating an account on a first social network with a first individual;
(b) associating said account with a trackable item;
(c) determining when said item is approaching a predetermined position;
(d) sending said advertisement to said first individual.

8. The method of claim 7, wherein said trackable item is a vehicle.

9. The method of claim 7, wherein said trackable item is a smartphone.

10. The method of claim 9, wherein determining when said item is approaching a predetermined position utilizes information inputted into said smartphone.

11. The method of claim 7, wherein said predetermined position is a physical storefront associated with said advertisement.

12. A method of connecting a first individual to a second individual comprises:
(a) associating an account on a first social network with said first individual;
(b) allowing said first individual to send a gesture on said first social network directed towards a second license plate.

13. The method of claim 12, wherein said gesture is associated with said second individual's driving.

14. The method of claim 12, wherein said second license plate is associated with a second account which is associated with a second individual.

15. The method of claim 13, wherein said gesture is stored on said first social network when said second license plate has not been claimed on said first social network.

16. The method of claim 13, wherein said gesture is cross-posted on a second social network.
